(19) United States
(12) Patent Application Publication
(10) Pub. No.: US 2006/0264223 A1
(43) Pub. Date: Nov. 23, 2006

(54) System and method for providing travel information to a mobile terminal in a wireless telecommunications network

(75) Inventors: Baoling S. Sheen, Naperville, IL (US); David S. Benco, Winfield, IL (US); Sanjeev Mahajan, Naperville, IL (US); Sandra Lynn True, St. Charles, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/134,990

(22) Filed: May 23, 2005

(51) Int. Cl. H04Q 7/20

(52) U.S. Cl. 455/456.5; 455/456.1

(57) ABSTRACT

A method of delivering travel information to a first wireless telecommunications network mobile terminal is provided. The method includes obtaining geolocation information for first and second mobile terminals over the wireless telecommunications network, a network element obtaining travel information using the geolocation information for the first and second mobile terminals, delivering the travel information to the first mobile terminal via the wireless telecommunications network. The travel information can include the location of the second mobile terminal and travel directions from the first mobile terminal to the second mobile terminal.

### BACKGROUND OF THE INVENTION

This invention relates to a system and method for providing travel information to a mobile terminal using geolocation information.

While the invention is particularly directed to the art of wireless telecommunications systems, and will be thus described with specific reference thereto, it will be appreciated that the invention may have usefulness in other fields and applications.

By way of background, wireless telecommunications have come into widespread use. Today, a large percentage of the population communicate with others using mobile terminals, also known as mobile phones, wireless phones, cellular phones, etc. Wireless telecommunications networks now provide coverage for such large areas that people can have the freedom to move about at will while still being able communicate with each other using these mobile devices.

Wireless telecommunications providers have sought to increase the number of people who use their networks by providing a wide range of services to their customers, also known as subscribers. Mobile terminals can now send and receive data and text messages in addition to providing voice communications. These terminals can also provide geolocation information that can be used to determine the location of the terminals. For example, geolocation information is used for determining the location of mobile terminals when dialing the emergency 911 number.

Wireless telecommunications service providers are usually always looking for new ways to accommodate the needs of their subscribers, given the ever increasing sophistication of mobile terminals. U.S. Pat. No. 6,650,902 to Richton assigned to Lucent Technologies which is hereby incorporated herein by reference in its entirety, describes using the geolocation providing ability of mobile terminals to provide information to the terminal when the location of the terminal satisfies a geolocation relationship with a geographic location. When a person with a mobile terminal travels near a location, the wireless telecommunications network provides the mobile terminal with location-specific information which can be useful to the traveler.

Oftentimes when traveling, two parties wish to reach the same destination by using different vehicles. This commonly occurs when both parties are driving to a destination in different cars. They may agree to follow each other, especially when one party is more familiar with the location of their destination. However, it can be difficult for two vehicles to stay in close proximity when traveling, especially if traffic is heavy or they encounter many traffic signals along the way. If separated, the two parties can communicate using their mobile terminals, however it can be hard to accurately describe one's location when traveling, and even more difficult to guide another party to within close proximity using the voice communications these mobile terminals provide.

The present invention contemplates a new and improved system and method that resolves the above-referenced difficulties and others.

### SUMMARY OF THE INVENTION

A system and method providing travel information to mobile terminal are provided.

In one aspect of the invention the method includes obtaining geolocation information for first and second mobile terminals over the wireless telecommunications network, a network element obtaining travel information using the geolocation information for the first and second mobile terminals, and delivering the travel information to the first mobile terminal via the wireless telecommunications network.

In accordance with another aspect of the invention, the travel information can include travel directions from the first mobile terminal to the second mobile terminal.

In accordance with another aspect of the invention, the system includes means for obtaining geolocation information for the first mobile terminal over the wireless telecommunications network, means for obtaining geolocation information for a second mobile terminal over the wireless telecommunications network, means for obtaining travel information using the geolocation information for the first and second mobile terminals, and means for delivering the travel information to the first mobile terminal over the wireless telecommunications network.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a portion of a wireless telecommunications system including a system for providing travel information to a mobile terminal;

FIG. 2 is a block diagram of a second embodiment of the system for providing travel information to a mobile terminal; and

FIG. 3 is a flowchart illustrating a method of providing travel information to a mobile terminal.

### DETAILED DESCRIPTION OF THE PREFERRED EMBODIMENTS

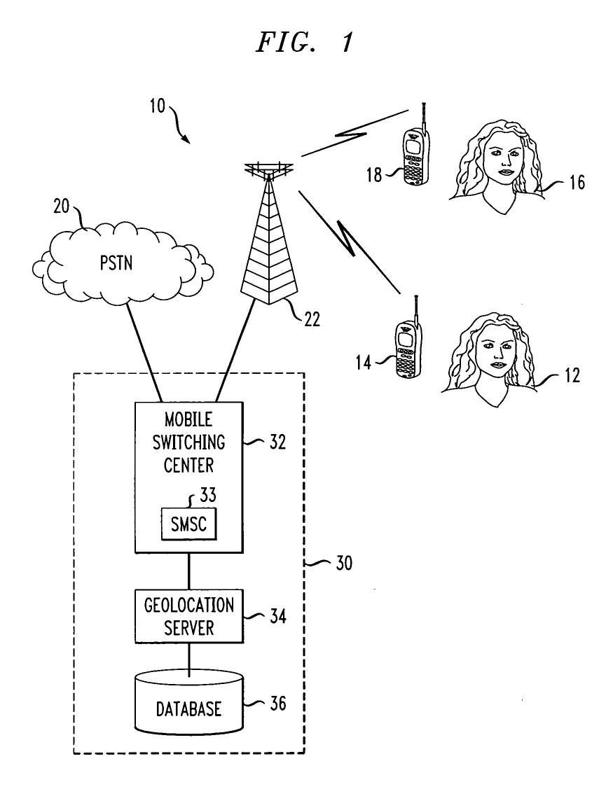

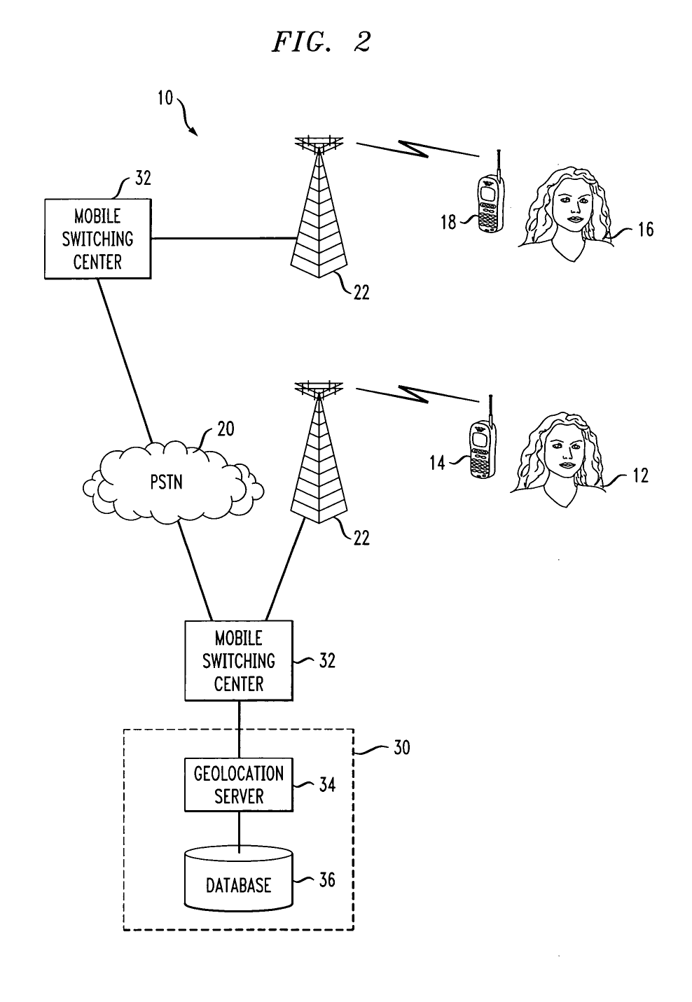

Referring now to FIGS. 1 and 2, a portion of a wireless communication network is shown generally at 10 for providing wireless telecommunications services to a first party 12 using a first mobile terminal 14 and a second party 16 using a second mobile terminal 18. The mobile terminals 14, 18 are also known as mobile phones, mobile handsets, or cellular phones.

It is contemplated that the mobile terminals 14 and 18 may utilize the same wireless telecommunications network 10 as is shown in the block diagram of FIG. 1, in that the parties 12, 16 are subscribers to telecommunications services provided by the same wireless telecommunications provider (not shown). Alternatively, as shown in FIG. 2, the mobile terminals 14, 18 may utilize the different wireless telecommunications networks for communicating with each other, either directly, or across the Public Switched Telephone Network (PSTN) 20 as shown.

The wireless telecommunications network includes a base station 22, as shown in FIG. 1, for providing over-the-air telecommunications to the mobile terminals 14, 18. It should be appreciated that the mobile terminals 14, 18 may be separated by sufficient distance so as to utilize separate base stations as is known in the art. Further, it should be appreciated that the mobile terminals 14, 18 may utilize different base stations 22, as shown in FIG. 2, each belonging to different wireless telecommunications providers for communicating with each other.

The wireless telecommunications network 10 also includes a travel information providing element shown generally at 30. As shown in FIG. 1, the travel information providing element 30 can include a Mobile Switching Center (MSC) 32 responsible for handling the wireless communications to and from the mobile terminals 14, 18 including such known functions as call setups and call routing, among others. The MSC 32 is typically connected to several base stations 22, each providing coverage for different geographic areas so as to provide over-the-air communications between the MSC and wireless terminals located near them. The MSC 32 can transmit data and/or text messages to the mobile terminals 14, 18, as is known in the art. For example, the MSC 32 can include, or is connected to, a Short Message Service Center for sending Short Message Service (SMS) messages to the mobile terminals 14, 18 as described below.

The travel information providing element 30 can also include a geolocation server 34 responsible for determining geolocation information for the wireless mobile terminals 14, 18. The geolocation information can be geographical coordinates, or other types of information used for determining and/or describing the location of the mobile terminals 14, 18. The geolocation server 34 can be a separate node, including but not limited to a processing node commonly referred to as a server, communicating with the MSC 32, or the functions of the geolocation server and MSC can be provided by the same element.

The travel information providing element 30 can also include a travel information database 36 capable of providing travel information corresponding to the location of the mobile terminals 14, 18. This travel information can include, but is not limited to, location information such as street addresses, etc., maps, and travel directions. It should be appreciated, however, that some or all of the travel information may be generated by the travel information providing element 30 rather than being retrieved from a storage element such as the database 36.

Referring again to FIG. 2, the travel information providing element 30 may be separate from the MSC 32 and capable of providing the travel information to the MSC via known connections for transmission to the mobile terminal 14 as described below.

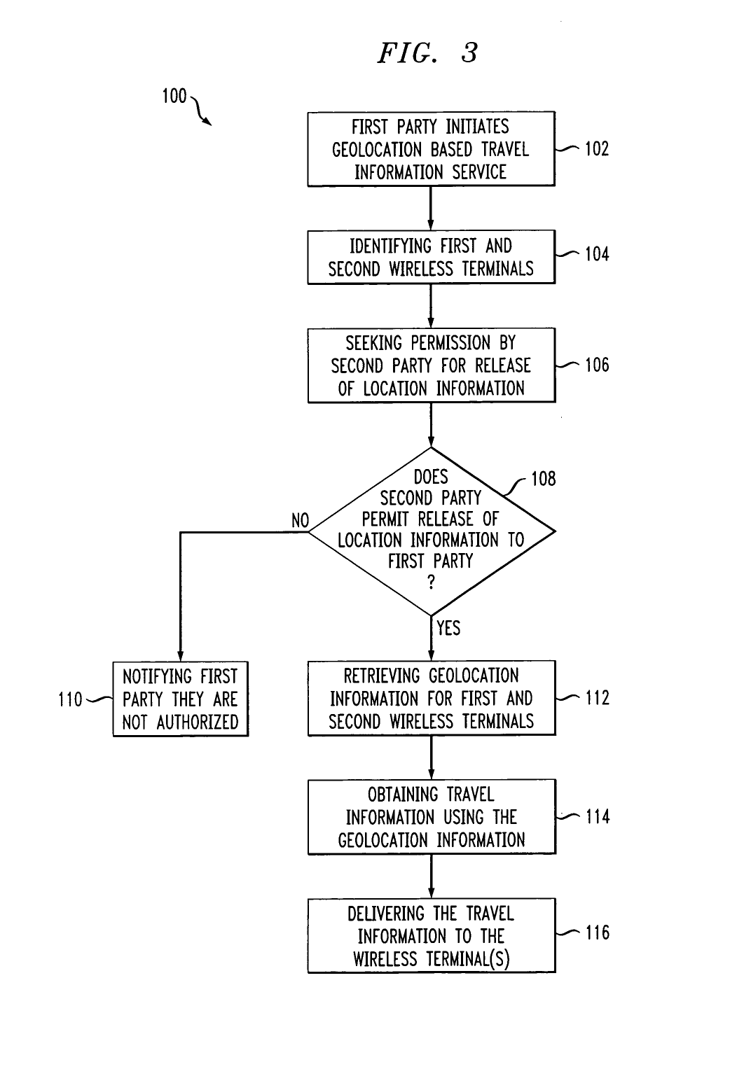

Referring now to FIG. 3, a method for delivering travel information to a mobile terminal is shown generally at 100. The method can be embodied as a feature provided by wireless telecommunications providers to subscribers who receive wireless telecommunications services from the provider. Third parties, such as vendors, etc. can also provide the feature to users, and as a result this service may be available to a wide range of mobile terminal users across, or via, different wireless telecommunications networks.

The method 100 includes a first party 12 initiating the geolocation feature at 102. The can take place when the first party 12 desires to find the location of the second party 16. By way of example, suppose the first party 12 and second party 16 are traveling to the same destination in separate vehicles. If the parties are not enroute together, or their vehicles get separated as may often happen when traveling by car, the first party 12 may wish to determine the location of the second party 16. The first party 12 can initiate the geolocation based travel information service using their mobile terminal 14 in a known manner for initiating wireless telecommunications based services, such as for example by sending message, referred to here generally as a travel information service request, to the travel providing element 30. The first party 12 can dial a phone number using the mobile terminal 14, or press a function initiating button on the mobile terminal, thereby communicating to the travel the information providing element 30 that the first party is initiating the geolocation based travel information service. The communication initiating this feature can use known messaging protocols that are transferred between the mobile terminal 14 and the information providing element 30. The travel information service request message can include an identifier identifying the other party terminal 18 as described below.

The first and second mobile terminals 14, 18 are identified by the travel information providing element 30 at 104. The terminals 14, 18 can be identified by associating them with one or more identifiers, such as for example, by their Mobile Identity Number (MIN), also known as their phone number, and/or their Electronic Serial Number (ESN), or other suitable known identifier(s). The first terminal 14 can be identified during its communications with the travel information providing element 30 when initiating the service at 104, or in other suitable ways. The first party 12 can identify the second mobile terminal 18 by providing the second mobile terminal MIN, or other identifiers, to the travel information providing element 30 using their mobile terminal 14, either in the initial travel serve request message or when prompted for it.

The information providing element 30 next seeks to obtain permission from the second party 16 for releasing the location information of their mobile terminal 18 to the first party 12. In this manner, the travel information providing element 30 can send a message to the second mobile terminal prompting the second party for this permission. Next, the travel information providing element 30 determines whether the second party 16 permits the release of the location information at 108. If the second party does not permit the release of this information, the travel information providing element 30 can notify the first party that they have not be authorized to receive the location of the second party 16 at 110. For the purposes of this example, the second party 16 agrees to permit the release of the location information to the first party 12 at 108. It is contemplated that permission for the release of this information can be sought in other ways.

The travel information providing element 30 next retrieves geolocation information for the first and second mobile terminals 14, 18 at 112. This information can be obtained in any suitable known manner. For example, the geolocation information can be geographic coordinates determined by the wireless communications system 10 by estimating their distances to the nearest known base stations 22 as described by Chen et al. in U.S. Pat. No. 6,748,224 assigned to Lucent Technologies which is hereby totally incorporated by reference herein in its entirety. The geolocation information can also be obtained by the terminals 14, 18, such as by using the Global Positioning System (GPS) and transmitted to the travel information providing element 30 over the wireless communications network 10.

The travel information providing element 30 then uses the geolocation information for both the first and second mobile terminals 14, 18 to obtain travel information at 114. The travel information is then delivered to the first mobile terminal 14 over the wireless telecommunications network 10, such as for example in a Short Message System message, or in other known manners. This travel information can also be provided to the second mobile terminal 18 if desired.

The travel information can include obtained at 114 can include, but is not limited to, the location of the second mobile terminal 18. The location information of the first mobile terminal 14 can also be provided is desired. This location information can be a street address, an intersection of the nearest streets, or even the geographic coordinates of the terminal(s), such as longitude and latitude. The location information can also be the location of one of the mobile terminals 14, 18 relative to the other mobile terminal 18, 14. For example, that the second mobile terminal 18 is traveling north 1000 feet south of the first mobile terminal 14. In this manner, the first party 12 can determine the location of the second party 16 using the geolocation information retrieved in step 112.

Furthermore, the location information can include travel directions from the location of the first terminal 14 to the location of the second terminal 18. The travel directions can be determined in any suitable manner, including being retrieved from the database 36, using the geolocation information retrieved in step 112. The travel directions can include the streets the first party should take, and directional information such as “turn right on Main Street” needed to travel to the second party. The travel directions can also include distance information, such as travel ½ mile on Main Street after turning right”. These travel direction can be delivered to the first mobile terminal using at 116 using the SMS message described above, or in other manners.

The travel information obtained at 114 using the geolocation information can also include one or more maps illustrating the travel directions and/or locations of the mobile terminals as described above. For example, a map showing the location and direction of travel of both terminals 14, 18 can be generated at 114 and delivered to the mobile terminal(s) over the wireless network 10 at 116. The map(s) can be transmitted as data, or in other known manners for transmitting graphics to mobile terminals.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of delivering travel information to a first wireless telecommunications network mobile terminal comprising:
obtaining geolocation information for the first mobile terminal over the wireless telecommunications network;
obtaining geolocation information for a second mobile terminal over the wireless telecommunications network;
a network element obtaining travel information using the geolocation information for the first and second mobile terminals; and
delivering the travel information to the first mobile terminal over the wireless telecommunications network.

2. The method defined in claim 1 wherein the travel information includes the location of the second mobile terminal.

3. The method defined in claim 2 wherein the travel information includes the street address of the second mobile terminal.

4. The method defined in claim 1 wherein the travel information is a map of the location of second mobile terminal.

5. The method defined in claim 4 wherein the travel information includes a map showing the locations of the first and second mobile terminals relative to each other.

6. The method defined in claim 1 wherein the travel information includes the direction of travel of the second mobile terminal.

7. The method defined in claim 1 wherein the travel information includes location information for one of the first and second mobile terminals relative to the other of the first and second mobile terminals.

8. The method defined in claim 1 wherein the travel information includes driving directions from the location of the first wireless to the location of the second mobile terminal.

9. The method defined in claim 1 further comprising seeking permission from a party via the second mobile terminal for releasing the location of the second mobile terminal.

10. A method of providing travel directions to a first mobile terminal comprising:
obtaining permission from a party via a second mobile terminal for releasing the location of the second mobile terminal;
obtaining geolocation information for the first mobile terminal over the wireless telecommunications network;
obtaining geolocation information for the second mobile terminal over the wireless telecommunications network;
a network element obtaining travel directions from the first mobile terminal to the second mobile terminal using the geolocation information for the first and second mobile terminals; and
delivering the travel directions to the first mobile terminal over the wireless telecommunications network.

11. A system for providing travel information to a first mobile terminal over a wireless telecommunications network comprising:
means for obtaining geolocation information for the first mobile terminal over the wireless telecommunications network;
means for obtaining geolocation information for a second mobile terminal over the wireless telecommunications network;
means for obtaining travel information using the geolocation information for the first and second mobile terminals; and
means for delivering the travel information to the first mobile terminal over the wireless telecommunications network.

12. The system defined in claim 11 wherein the travel information includes the location of the second mobile terminal.

13. The system defined in claim 12 wherein the travel information includes the street address of the second mobile terminal.

14. The system defined in claim 11 wherein the travel information is a map of the location of second mobile terminal.

15. The system defined in claim 11 wherein the travel information includes driving directions from the location of the first wireless to the location of the second mobile terminal.

16. The system defined in claim 11 wherein the travel information includes location information for one of the first and second mobile terminals relative to the other of the first and second mobile terminals.

17. The system defined in claim 11 further comprising:
means for obtaining permission from a party via the second mobile terminal for releasing the location of the second mobile terminal.
